(19) United States
(12) Patent Application Publication
(10) Pub. No.: US 2011/0219159 A1
(43) Pub. Date: Sep. 8, 2011

(54) USB DONGLE DEVICE AND OPERATION METHOD THEREOF, DONGLE EXPANDED DEVICE CONNECTED TO USB DONGLE DEVICE

(75) Inventor: Gun Hee Park, Suwon-si (KR)

(73) Assignee: SAMSUNG ELECTRONICS CO., LTD., Suwon-si (KR)

(21) Appl. No.: 13/040,070

(22) Filed: Mar. 3, 2011

(30) Foreign Application Priority Data
Mar. 3, 2010 (KR) 10-2010-0019075

(51) Int. Cl. G06F 13/00

(52) U.S. Cl. 710/300

(57) ABSTRACT

A universal serial bus (USB) dongle device and method support a connection to a dongle expanded device to perform high speed and multiple communications while observing a USB standard form. The USB dongle device includes a body and a plug formed in an edge of one side of the body. The plug includes a basic connection unit corresponding to a USB basic connection port and an expansion connection unit surrounding the basic connection unit, in which at least one signal line is formed.

### CROSS-REFERENCE TO RELATED APPLICATION(S) AND CLAIM OF PRIORITY

The present application is related to and claims the benefit under 35 US.C. §119 a of a Korean patent application filed in the Korean Intellectual Property Office on Mar. 3, 2010 and assigned Serial No. 10-2010-0019075, and the entire disclosure of which is hereby incorporated by reference.

### TECHNICAL FIELD OF THE INVENTION

The present invention relates to a USB dongle device and, more particularly, to a USB dongle device which is capable of performing high speed communications and multiple communications and to a dongle expanded device that connects to the USB dongle device.

### BACKGROUND OF THE INVENTION

A dongle device is a small hardware connected to a computer, which can be carried like a USB flash drive. Initially, it was used for a computer software authentication, but the term ‘dongle’ is also now widely used as a term for a broadband wireless adapter. The dongle device may include various interior components, such as a communications modem for the support of wireless communications, a memory for storing data, a built-in communications modem and, a central processing unit for memory access and use control. The dongle device does not have a separate battery but is provided with power from a connected host apparatus to operate. The dongle device has an interface, i.e., a plug that connects with the host apparatus. The plug is formed according to a USB standard format. Accordingly, although high-speed data transmission and processing are possible in the internal compositions, the existing dongle device supports only data transmission based on a plug type of USB standard format, such that it has a limit in the transmission and processing of high speed and high-capacity data. And the existing dongle device is available only when it is connected to a PC or some other host apparatus for use. Accordingly, there is a problem in that a user service support form based on the dongle device is dependent on the connected PC even though the performance of the dongle device has been improved.

### SUMMARY OF THE INVENTION

To address the above-discussed deficiencies of the prior art, it is a primary object to provide a USB dongle device that includes a plug type which is formed to be able to perform high speed and multiple communications while observing a USB standard type, and an operating method thereof.

The present invention further provides a dongle expanded device connected to USB dongle device which supports to connections to a special host apparatus of the existing USB dongle device to independently operate.

In accordance with an aspect of the present invention, a universal serial bus (USB) dongle device includes a body and a plug formed in an edge of one side of the body. The plug includes a basic connection unit corresponding to a USB basic connection port and an expansion connection unit surrounding the basic connection unit, in which at least one signal line is formed.

In accordance with another aspect of the present invention, a dongle expanded device connects to a universal serial bus (USB) dongle device. The dongle expanded device includes a connector configured to couple to the USB dongle device. A power supply unit supplies power to the USB dongle device through the connector. A display unit outputs data received from the USB dongle device through the connector. And an audio input/output unit outputs an audio signal received from the USB dongle device through the connector, and sends a collected audio signal to the USB dongle device.

In accordance with another aspect of the present invention, an operating method of a universal serial bus (USB) dongle device includes detecting a connection of the USB dongle device to an external device. The USB dongle device includes a basic connection unit for USB connection and an expansion connection unit surrounding the basic connection unit that includes at least one signal line. A signal path is controlled to block or maintain a signal path for the expansion connection unit according to a type of the external device.

According to a USB dongle device and an operating method thereof and to a dongle expanded device connected to the USB dongle device, the present invention can perform high speed and multiple communications, and may conveniently and simply use a user service which may be supported by only constructions mounted in a USB dongle device based on a dongle-expanded device connected to the USB dongle device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view schematically illustrating an appearance of a USB dongle device according to an embodiment of the present invention;

FIG. 2 illustrates a detailed view of an area “A” of FIG. 1;

FIG. 3 illustrates a cross-sectional view of a plug shown in FIG. 2;

FIG. 4 illustrates a block diagram of a configuration of a USB dongle device according to an embodiment of the present invention;

FIG. 5 illustrates a detailed view of a switch unit of FIG. 4;

FIG. 6 is a perspective view schematically illustrating an appearance of a dongle-expanded device connected to the USB dongle device according to an embodiment of the present invention;

FIG. 7 illustrates a block diagram of a configuration of a dongle-expanded device according to an embodiment of the present invention;

FIG. 8 illustrates a configuration of a connector of a dongle-expanded device to which a plug of the USB dongle device is inserted according to an embodiment of the present invention; and

FIG. 9 illustrates a process of the USB dongle device and the dongle-expanded device according to the present invention.

### DETAILED DESCRIPTION OF THE INVENTION

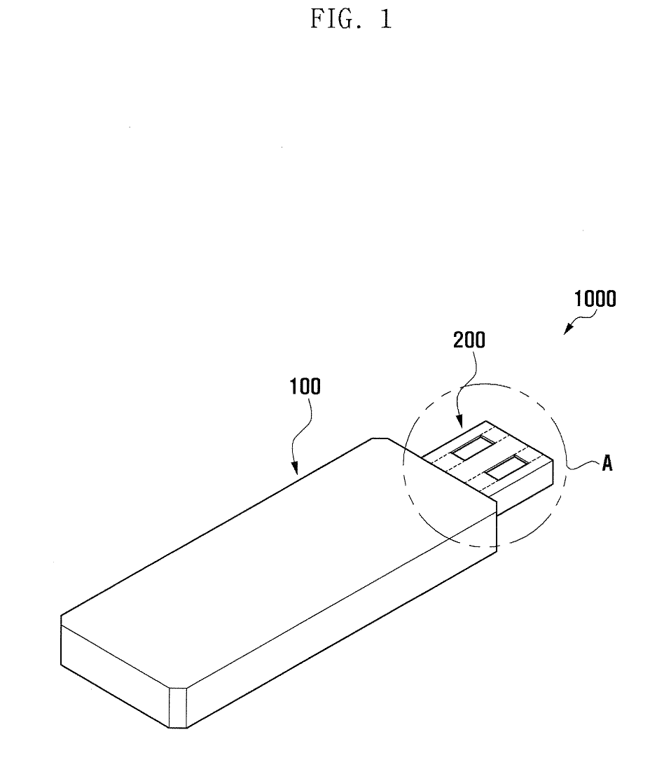

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged USB dongle device. Detailed descriptions of well-known functions and structures incorporated herein may be omitted to avoid obscuring the subject matter of the present invention.

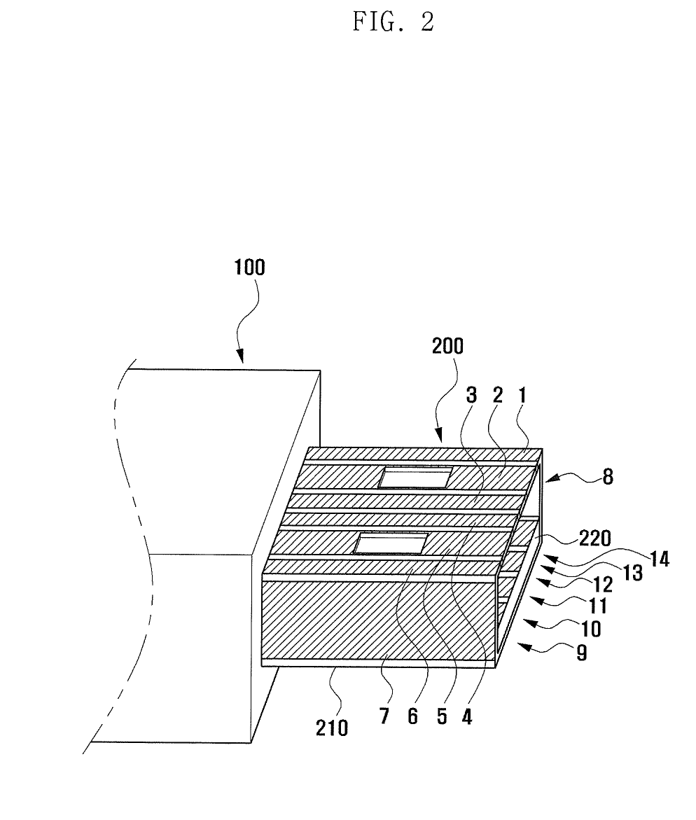

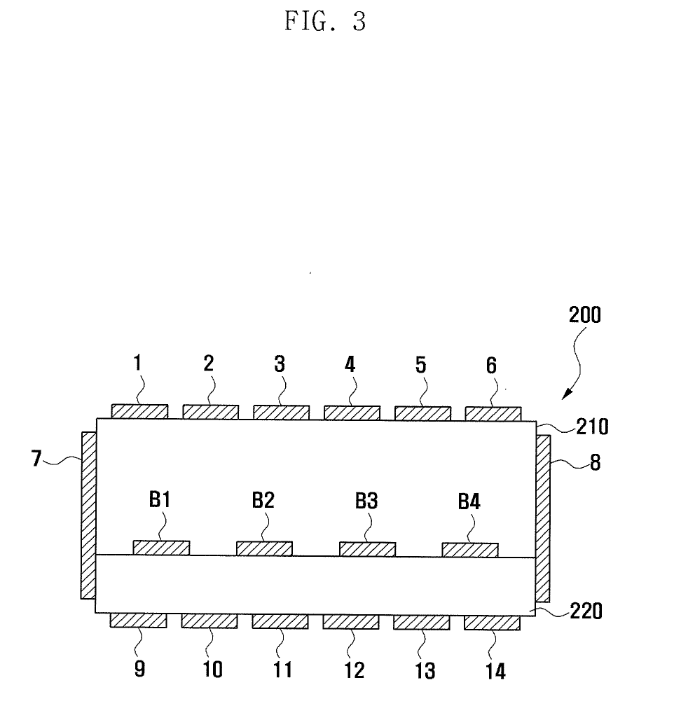

FIG. 1 is a perspective view schematically illustrating an appearance of a USB dongle device according to an embodiment of the present invention; FIG. 2 illustrates a detailed view of an area “A” of FIG. 1; and FIG. 3 illustrates a cross-sectional view of a plug shown in FIG. 2.

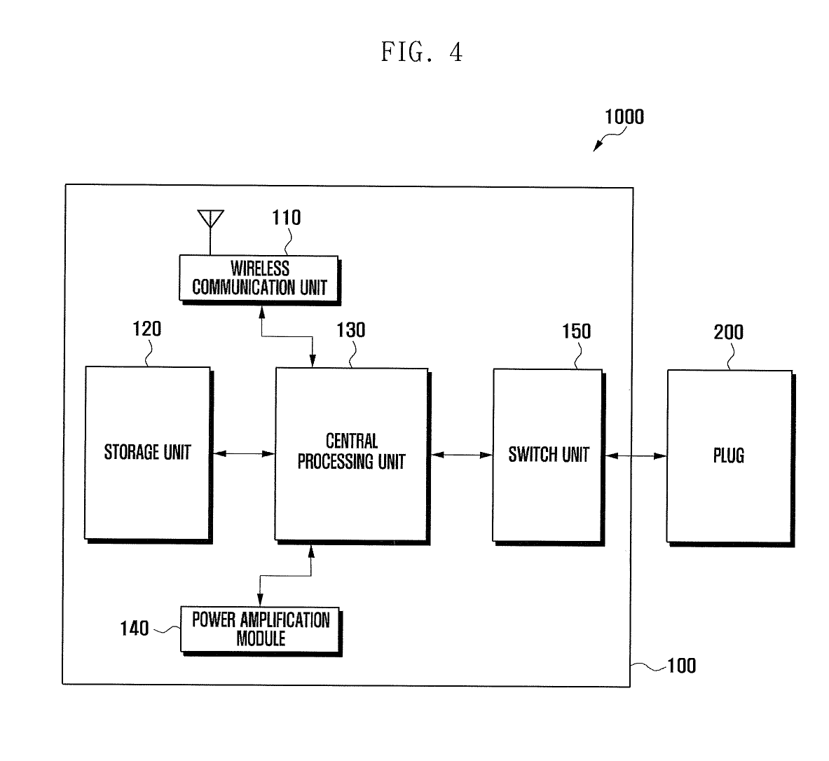

Referring to FIG. 1 to FIG. 3, a USB dongle device 1000 of the present invention includes a body 100 and a plug 200. Here, the body 100 may include a wireless communication unit, a storage unit, and a central processing unit. That is, the body 100 is connected to a dongle-expanded device to be described later, and may include elements for supporting a user service, for example, a wireless calling service, a contents playing service, and a file edit service which may be fundamentally provided. Internal constructions of the body 100 will be explained with reference to FIG. 4 in detail. The body 100 may include a case of a given form. The case may be configured to surround the internal constructions and fix the plug 200 according to a manufacturing form. Here, the plug 200 may be manufactured to be retractable into the case. At this time, the case may perform a function surrounding the plug 200 according to a location of the plug 200. The case engages with an end of a side of the plug 200 such that the plug 200 may be firmly supported and oriented in a given direction.

The plug 200 is coupled to a connector of a peripheral device. The plug 200 includes a basic connection unit 220 according to a USB standard and an expansion connection unit 210 for supporting high speed multiple-communication.

The basic connection unit 220 includes an access port according to the USB standard. Here, the USB standard is based on four access ports B1, B2, B3, and B4 in the current 2.0 version, and is also based on four or more access ports in the 3.0 version.

Consequently, according to the change in the standard, the number of the access ports of the basic connection unit 220 may be added or reduced. The basic connection unit 220 may be fundamentally provided for data exchange and power supply with connected peripheral devices. The basic connection unit 220 may include signal lines provided at a surface of a support member and the support member such that a signal line corresponding to an access port is firmly maintained while being connected to the connector.

The signal lines may correspond to the foregoing access ports B1, B2, B3, and B4. The expansion connection unit 210 may be manufactured to include a support structure surrounding the basic connection unit 220 while firmly maintaining a mechanical connection state upon accessing a peripheral device, and at least one signal line formed at a side of the support structure. Because a separate hook or locking structure is not used when the plug 200 is generally connected to a connector of the peripheral device, a framework of the expansion connection unit 210 of the present invention may be manufactured to lock with the connector of the peripheral device in the artificial fitting form. When a connector form of a host device has a separate locking structure such as hook, an appearance of the expansion connection unit 210 may change corresponding to the connector form.

In the meantime, at least a part of an outer surface and an inner side of the support structure is formed of a metal material. The expansion connection unit 210 of the present invention includes at least one signal line that is formed in at least one of the outer surface and the inner side of the support structure such that the outer surface of the support structure formed by the metal material may partially perform a function of an access port.

For example, as shown, the expansion connection unit 210 may be formed with a rectangular parallel-piped hollow support structure. Signal lines functioning as an access port may be formed at one side of the rectangular parallel-piped hollow support structure.

Referring to drawings, in detail, first to sixth signal lines 1, 2, 3, 4, 5, and 6 are formed at an upper surface of the rectangular parallel-piped hollow support structure in the expansion connection unit 210. Respective seventh and eighth signal lines 7 and 8 may be formed at the side and vertically contacts with each other with an upper side. Respective ninth to fourteenth signal lines 9, 10, 11, 12, 13, and 14 may be formed at a lower side facing the upper side.

Here, the number of respective signal lines may be reduced or increased according to the intention of a designer making the expansion connection unit 210. That is, the expansion connection unit 210 may include a signal line formed in at least one of an upper side, both lateral sides, or a lower side of the support structure according to the intent of the designer. The expansion connection unit 210 was described as a signal line formed by a hollow rectangular support structure. However, the present invention is not limited thereto. The signal line provided in the expansion connection unit 210 may be formed on at least one of an inner surface of the upper side or an inner surface of both lateral sides of the support structure. Accordingly, it should be understood that the present invention may include a signal line formed at any specific location of the support structure surrounding the basic connection unit 220 other than the basic connection unit for supporting a USB standard.

The support structure surrounding the basic connection unit 220 may be manufactured by a non-conductive material, e.g., wood, plastic, reinforcing rubber, and so forth, such that the expansion connection unit 210 operates as a signal line. The signal line is formed on the surface of the expansion connection unit 210 by a conductive material, e.g., aluminum, chrome, zinc, silver, copper, and such. The signal lines of the expansion connection unit 210 may be manufactured by coating the outer surface of the non-conductive support structure with a copper foil and etching various forms of the signal lines according to the intent of a designer.

FIG. 4 illustrates a block diagram of a configuration of a USB dongle device 1000 according to an embodiment of the present invention.

Referring to FIG. 4, the USB dongle device 1000 may include a wireless communication unit 110, a storage unit 120, a central processing unit (CPU) 130, a power amplification module 140, a switch unit 150, and a plug 200. Here, the wireless communication unit 110 may include a plurality of modems according to a form of a communication system that the USB dongle device 1000 supports, and the power amplification module 140 may be removed according a manufacturing type.

The wireless communication unit 110 is configured to support a communication service of a connected host device. When the USB dongle device 1000 connects with a peripheral device, the wireless communication unit 110 performs initialization based on power supplied from the peripheral device and data stored in the storage unit 120.

The wireless communication unit 110 may transmit data requested from a peripheral device under the control of the CPU 130 and send data received from an exterior to the CPU 130. The wireless communication unit 110 may be a form of a modem capable of supporting at least one of various communication schemes, for example, a mobile communication modem such as CDMA (Code Division Multiple Access), WCDMA (Wideband Code Division Multiple Access), or GSM (Global System for Mobile Communications), and a mobile data communication model such as HSDPA (High-Speed Downlink Packet Access) or WiBro (Wireless Broadband). The wireless communication unit 110 may form a communication channel for voice call based on the data transmission and reception and a communication channel for transmitting images or data under the control of the CPU 130. Namely, the wireless communication unit 110 forms a voice call channel, a data communication channel, and an image call channel between communication systems. To this end, the wireless communication unit 110 may include a transmitter for up-converting a frequency of a transmitted signal and amplifying the signal, and a receiver for low-noise-amplifying a received signal and down-converting the signal. As illustrated above, the wireless communication unit 110 may be configured in a form of a multi-band modem or a multi-modem covering a plurality of communication bands.

Meanwhile, when a Subscriber Identification Module (SIM) is utilized for operation of the wireless communication unit 110, the USB dongle device 1000 may further include an interface for inserting a SIM card and for communicating with a SIM card inserted in the insertion interface.

The storage unit 120 may store data for driving the USB dongle device 1000, data input from a dongle-expanded device, and data sent from a host device such as PC. The data for driving the USB dongle device 1000 may be accessed based on power provided from a host device or a dongle-expanded device and the CPU 130, and be data for initializing the wireless communication unit 110. Furthermore, the data may contain information such as a phone book and other contents. In particular, when the USB dongle device 1000 connects with a peripheral device, for example, a host device or a dongle-expanded device, the storage unit 120 may store a table capable of determining a type of the connected peripheral device. Moreover, when the dongle-expanded device includes a touch screen as a display unit, the storage unit 120 may store various maps, for example, key map, menu map, and a control key map to be output on the touch screen. When the dongle-expanded device is connected, the maps may be displayed on a touch screen provided at the dongle-expanded device under the control of the CPU 130. Moreover, the storage unit 120 may include a control table capable of changing states of various signal lines provided at the plug 200 according to a type of a connected peripheral device. The control table may be loaded in the CPU 130 according to the connected peripheral device to determine respective switch states of the switch unit 150.

When the CPU 130 receives power from a connected host device or a connected dongle-expanded device, it controls initialization using the supplied power. Moreover, the CPU 130 may determine whether the peripheral device is a host device or a dongle-expanded device according to a connected state. To this end, the CPU 130 may refer to the table stored in the storage unit 120. For example, the CPU 130 may detect resistance variation or voltage variation in a specific position according to a connection of a peripheral device, and may determine a type of the peripheral device based on the resistance variation or the voltage variation.

In addition, the CPU 130 may communicate with the peripheral device to determine a type of the peripheral device. When the type of the peripheral device is determined, the CPU 130 may read data necessary for association with the peripheral device or activate programs necessary for association with the peripheral device.

In particular, when the peripheral device is a dongle-expanded device, the CPU 130 of the present invention controls the wireless communication unit 110 to be activated and searches neighboring base stations based on the wireless communication unit 110 to enter a state capable of supporting a communication service.

Furthermore, the CPU 130 may change each switch state of the switch unit 150 to a state for association with the dongle-expanded device by referring to the control table stored in the storage unit 120.

In detail, the CPU 130 may maintain the basic connection unit 220 and the expansion connection unit 210 in a state capable of exchanging data upon association with the peripheral device. To this end, the CPU 130 may cause signal lines connected to the expansion connection unit 210 to be in a state usable as a data signal line. That is, the CPU 130 may control a setting of the switch unit 150 to form a data signal path with signal lines of the expansion connection unit 210. Upon association with a host device with a control unit, when the CPU 130 is controlled to use only a basic connection unit 220, it may set a state of the switch unit 150 to float or ground the expansion connection unit 210. For example, it is assumed that the basic connection unit 220 and the expansion connection unit 210 is designed to be used upon connection of the dongle-expanded device and only the basic connection unit 220 is designed to be used upon connection of a peripheral device with a controller, for example, a personal computer (PC). Accordingly, when the dongle-expanded device is connected, the CPU 130 may control the setting of the switch unit 150 to perform power supply and data exchange with the dongle-expanded device using the basic connection unit 220 and the expansion connection unit 210. Furthermore, when the PC is connected, the CPU 130 may control the setting of the switch unit 150 to support power supply and data exchange using only the basic connection unit 220 and control the expansion connection unit 210 to be floated or grounded.

As illustrated above, when the dongle-expanded device is connected, the CPU 130 may send various data stored in the storage unit 120 and data created according to an operation of the wireless communication unit 110 to the dongle-expanded device through the basic connection unit 220 and the expansion connection unit 210. In detail, the CPU 130 may transmit and receive screen data corresponding to an idle screen, phone number data according to phone book information, call request receiving data, voice data exchanged through the wireless communication unit 110, a key input signal or a touch event created by the dongle-expanded device through the basic connection unit 220 and the expansion connection unit 210. Accordingly, the CPU 130 may support a fundamental communication service through the dongle-expanded device. Power may be supplied to the USE dongle device 1000 through the basic connection unit 220.

The power amplification module 140 may be configured to be designed in consideration of a situation in which a power amplification module is not included in the peripheral device. That is, the power amplification module 140 may amplify power provided from the peripheral device to a signal necessary for activation of the USB dongle device 1000 and send the amplified signal to respective components included in the USB dongle device 1000 under the control of the CPU 130.

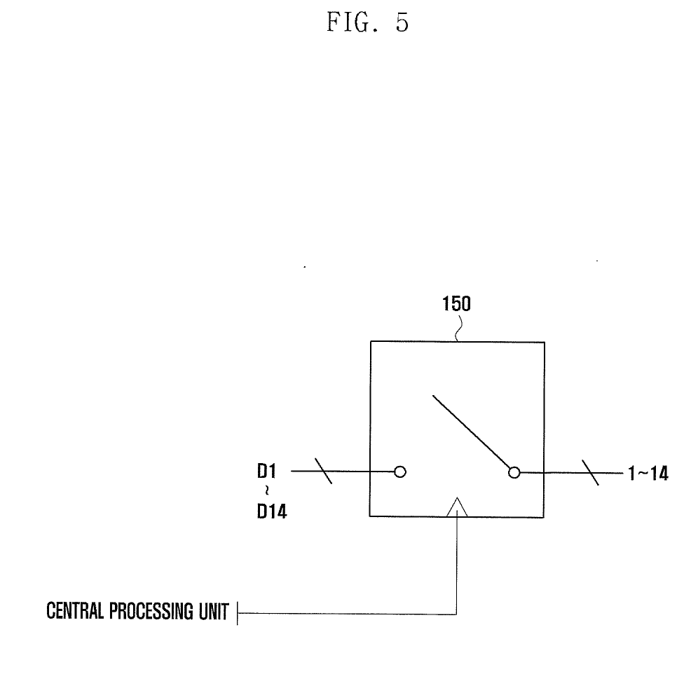

The switch unit 150 may set signal lines of an expansion connection unit 210 provided at the plug 200 to a usable or unavailable form in the CPU 130 under the control of the CPU 130. Referring to FIG. 5, the switch unit 150 is arranged between signal lines 1˜14 of the plug 200 and data signal lines D1˜D14 connected to the CPU 130. Although the switch unit 150 is shown as one switch, it may include a plurality of switches connecting respective signal lines 1˜14 and the data signal lines D1˜D14 with each other. That is, the number switches of the switch unit 150 can be changed according to the number of signal lines provided at the expansion connection unit 210. Moreover, it is shown that the switch unit 150 can change to a floating state when the expansion connection unit 210 is not used. However, the switch unit 150 may control to ground signal lines included in the expansion connection unit 210. When the expansion connection unit 210 is not used, the switch unit 150 may prevent input of static electricity and other dummy data from the expansion connection unit 210. When the USB dongle device 1000 of the present invention is not configured to prevent input of separate static electricity and dummy data, the switch unit 150 may be omitted.

As illustrate earlier, in the USB dongle device 1000 according to an embodiment of the present invention, an expansion connection unit 210 is additionally provided at the plug 200 to support data exchange of a connected peripheral device such that it may rapidly send or receive large data to or from the peripheral device.

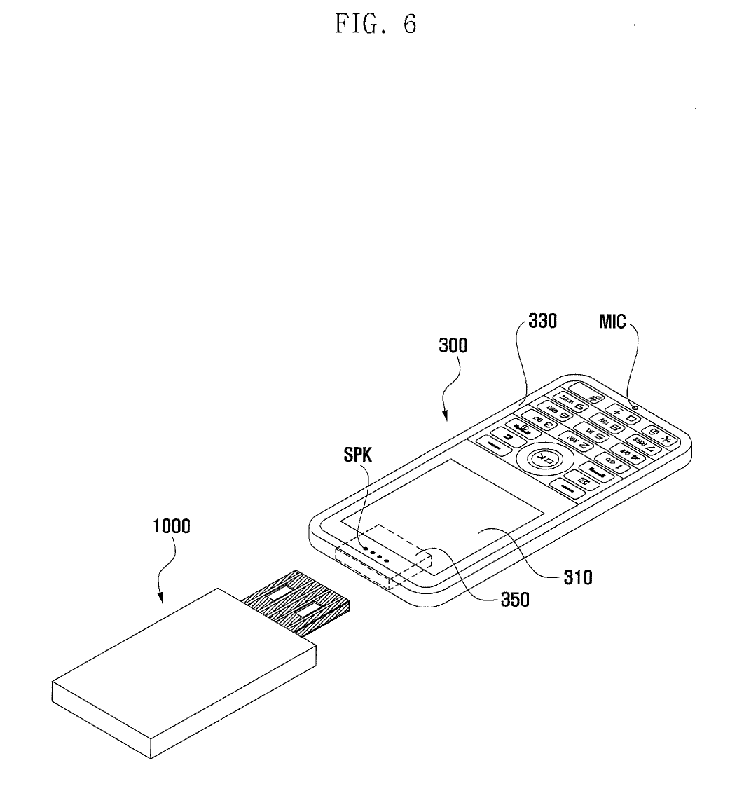

FIG. 6 is a perspective view schematically illustrating an appearance of a dongle-expanded device connected to the USB dongle device according to an embodiment of the present invention.

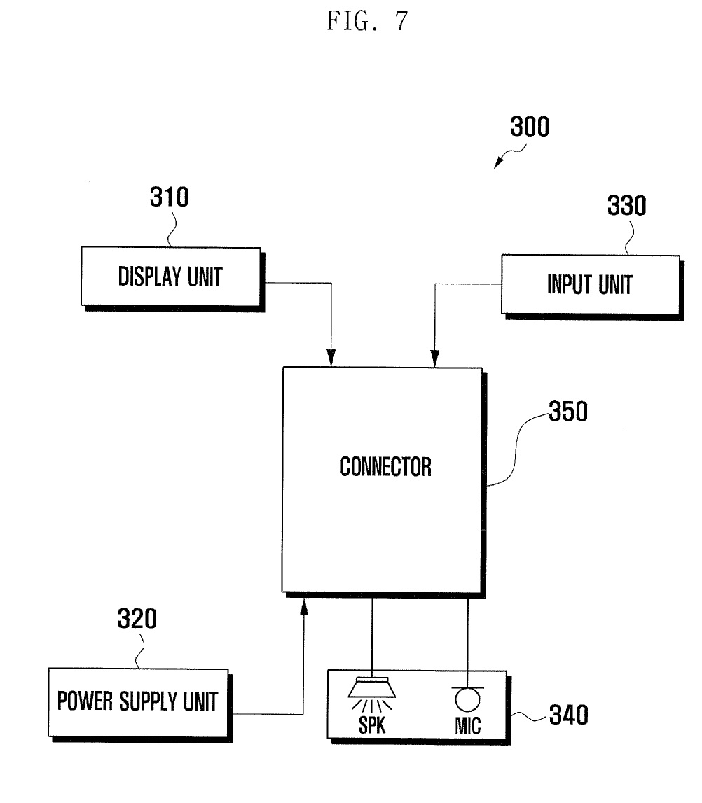

FIG. 7 illustrates a block diagram of a configuration of a dongle-expanded device according to an embodiment of the present invention.

Here, the dongle expanded device 300 may be an external device that supplies power to the USB dongle device 1000 that does not include a controller. Referring to FIGS. 6 and 7, the dongle expanded device 300 of the present invention may include a display unit 310, a power supply unit 320, an input unit 330, an audio input/output unit 340 and a connector 350. The dongle expanded device 300 is connected to the USB dongle device 1000 and controls to process various data which the USE dongle device 1000 sends, and to transmit data generated by user control to the USB dongle device 1000, such that it can support a USB dongle device 1000 based service, such as the confirmation, the play, the editing and the deletion of data stored in the USE dongle device 1000, and a wireless communications unit 110 based communications service included in the USE dongle device 1000. Hereinafter, the configuration of the dongle expanded device 300 is illustrated in detail. The display unit 310 is an element for outputting data sent from the USB dongle device 1000. That is, the display unit 310 displays various information stored in the storage 120 and information received through the wireless communications unit 110 as well as various menus which the USB dongle device 1000 provides.

That is, the display unit 310 may provide various screens according to the usage of USE dongle device 1000, e.g., stand-by screen, menu screen, message writing screen, call screen and such.

This display unit 310 can be implemented as a liquid crystal display (LCD) or an organic light emitted diode (OLED). As described above, the display unit 310 can provide a touch screen function when the touch panel is arranged in an upper portion. The display unit 310 may also output the above described key map. In this process, according to the control of display unit 310, the touch panel may set an area corresponding to the key map as an effective area, and may send the touch event generated in the effective area to the central processing unit 130 of the USB dongle device 1000. The power supply unit 320 supplies a power necessary for the operation of USB dongle device 1000. This power supply unit 320 may be comprised of a charge battery in consideration of portability and mobility of the dongle expanded device. And the power supply unit 320 can be designed to supply a voltage and a current suitable for the power used in the USE dongle device 1000.

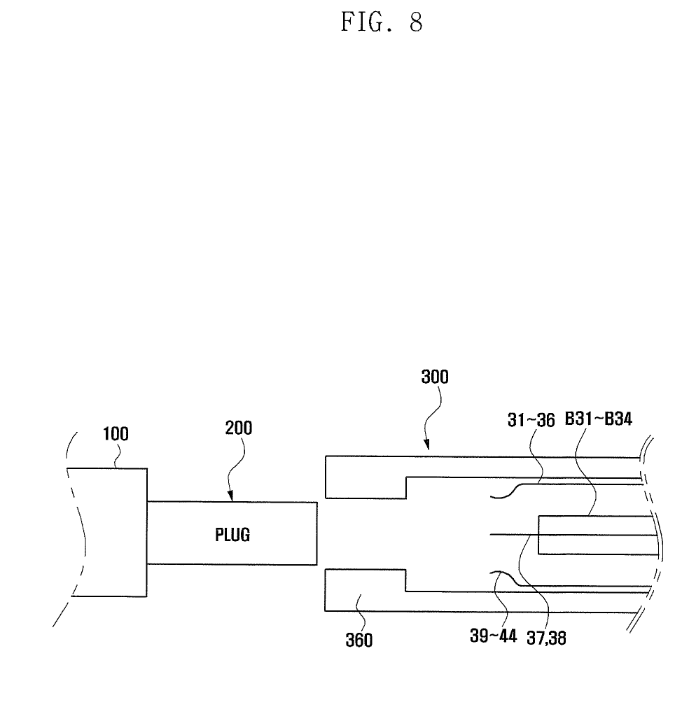

Moreover, because the power supply unit 320 is configured as a charge battery type, it may further include a charge interface, e.g., an adapter connection interface for charging the battery through an adapter. The power supplied by the power supply unit 320 may be changed into a power applicable to the USE dongle device 1000 through the power amplification module 140 of the USB dongle device 1000, and support the central processing unit 130 to examine the voltage or the current of the power, such that the USB dongle device 1000 may obtain the information of power residual. Accordingly, the dongle expanded device 300 receives the information of power residual of the power supply unit 320 from the USB dongle device 1000 and may output it to the display unit 310. Alternatively, the dongle expanded device 300 may further include a residual examination and output circuit that can directly output the residual information of power supply unit 320 to the display unit 310 so as to easily recognize the time point of charging the power supply unit 320. The input unit 330 is an element for generating an input signal according to user input and can be implemented with a button or keypad type. At this time, when the display unit 310 provides a touch screen function while an input of various numbers and characters is possible through the touch screen, the input unit 330 may be manufactured in the form of a side key or a navigation key arranged in an area where the display unit 310 is not formed. The input signal generated in the input unit 330 is sent to the USB dongle device 1000 through the connector 350. And, accordingly, the central processing unit 130 determines the type of the sent input signal and performs a corresponding operation. When the display unit 310 provides a touch screen function such that a structure for the generation of a separate input signal is unnecessary, the input unit 330 may be removed in the dongle expanded device 300. The audio input/output unit 340 may include a speaker (SPK) that receives an audio signal generated in the USB dongle device 1000 through the connector 350 to output, and a microphone (MIC) that collects the voice or the neighboring audio signal and sends it through the connector 350 to the USB dongle device 1000. Here, the speaker (SPK) may output not only a voice signal generated according to the operation of the wireless communications unit 110 but also an audio signal generated when playing the contents of a file stored in the storage 120. The audio input/output unit 340 may further include an ear jack, and may control to change an audio output path in the connection of earphone such that the audio signal is outputted through the ear jack. Additionally, the dongle expanded device 300 of the present invention may include a vibrating unit including at least one vibrating motor. The vibrating unit may operate, under the control of the central processing unit 130, according to alarm, call receipt, or other contents playing. The connector 350 is an element that physically connects each element. The connector 350 is connected to the plug 200 of the USB dongle device 1000 and plays a role of directing signal paths to support various user functions. As shown in FIG. 8, this connector 350 may include respective signal lines for the electrical connection of a basic connection unit formed in the plug 200 with an expansion connection unit.

In more detail, the connector 350 of the present invention may include an insertion unit 360 which forms an insertion hole to which the plug 200 may be inserted and various contact terminals which are coupled with signal lines formed in the plug 200 after the insertion of plug 200. That is, the contact terminals included in the connector 350 include at least one expansion contact terminal electrically contacted with an expansion connection unit 210 of the plug 200 and contact terminals contacted with a basic connection unit 220.

The expansion contact terminals includes a first contact terminal to a sixth contact terminal (31˜36) which are contacted respectively with a first signal line to a sixth signal line (1˜6) formed in an upper surface, a seventh contact terminal and an eighth contact terminal (37, 38) which are contacted respectively with a seventh signal line and an eighth signal line (7, 8) formed at corresponding lateral sides of the expansion connection unit 210, and a ninth contact terminal to a fourteenth contact terminal (39˜44) which are coupled respectively with a ninth signal line to a fourteenth signal line (9˜14) formed in a lower surface. And the connector 350 may include basic contact terminals (B31˜B34) for coupling with the basic connection unit 220. Here, it is illustrated that the contact terminals of the connector 350 are formed in accordance with signal lines formed in the plug 200. However, if the number of the signal lines formed in the plug 200 is less or more than the above described number, then, accordingly, the contact terminals of the connector 350 may be formed with less or more number. When the plug 200 enters through the insertion unit 360, the connector 350 is electrically connected to respective signal lines formed in the plug 200, such that the power stored in the power supply unit 320 may be supplied to the connector 350. To this end, it is preferable that the power supply unit 320 is arranged to automatically supply power when the plug 200 is inserted to the connector 350.

When the USB dongle device 1000 and the dongle expanded device 300 are connected, initialization may be performed based on the power of power supply unit 320 of dongle expanded device 300. At this time, the initialization of the display unit 310, the audio input output unit 340, and the input unit 330 included in the dongle expanded device 300 may be performed under the control of the central processing unit 130 included in the USE dongle device 1000. For example, while the display unit 310 included in the dongle expanded device 300 performs initialization under the control of the central processing unit 130 of the USB dongle device 1000, it can perform a touch panel setting under the control of the central processing unit 130 when being manufactured with a touch screen that includes a touch panel.

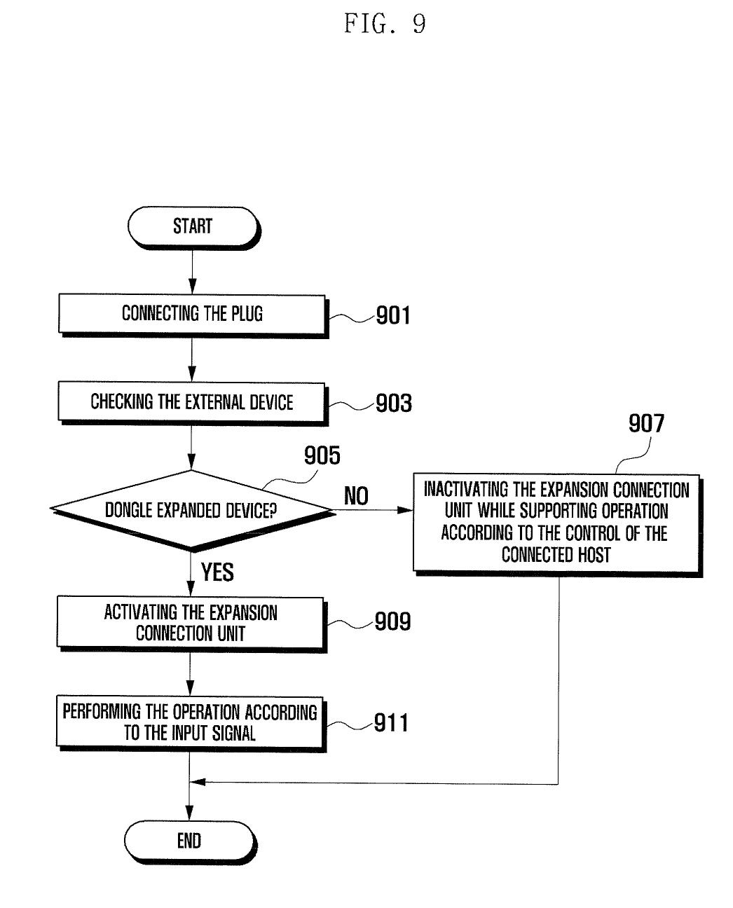

By using configurations arranged in the USB dongle device 1000, the USB dongle device 1000 and the dongle expanded device 300 of the present invention can support a specific user function, e.g., a wireless communications function, a contents playing function, a file edit and delete function, and a file retrieval function stored in a storage of the USB dongle device 1000 without a separate connection to a PC. Accordingly, although a specific PC terminal is not used for the USB dongle device 1000, a user can easily and conveniently use a simple user function which the USB dongle device 1000 can provide, e.g., the mobile communications function, the contents playing function. The configuration and external shape of the USB dongle device 1000 and the dongle expanded device 300 according to an embodiment of the present invention was illustrated. Hereinafter, the operation method of the USB dongle device 1000 is illustrated in detail with reference to FIG. 9.

FIG. 9 illustrates a process of the USE dongle device 1000 and the dongle-expanded device according to the present invention.

Referring to FIG. 9, with respect to the USB dongle device 1000, when the plug 200 is coupled to the connector of the external device (block 901), the USB dongle device 1000 checks the connected external device (block 903). In this process, the USB dongle device 1000 may passively or actively determine the type of the external device being connected. That is, when the USB dongle device 1000 is connected to PC, the PC side may recognize the connection of the USE dongle device 1000 and send a signal necessary for the operation of the USE dongle device 1000 to the USE dongle device 1000.

In an embodiment, the USE dongle device 1000 may determine the type of the external device to which it is currently connected based on the received signal. For example, when an element that has no internal data processing unit like the above described dongle expanded device is connected, i.e., a device that does not include controller, the USB dongle device 1000 is provided with power from the connected external device and performs the initialization of each element arranged in the USB dongle device 1000 based on the provided power.

In some embodiments, the USB dongle device 1000 may perform the process of checking the type of the connected external device, e.g., the process of checking the type of the connected external device through the change of resistance or voltage caused by the connection of external device or the process of checking the type of the connected external device according to the form of the signal received through the communications with the external device. Because the USB dongle device 1000 has no internal power supply unit, it receives power from outside and performs the recognition of external device.

In block 905, the USB dongle device 1000 checks whether the external device is a dongle expanded device. When the external device is not a dongle expanded device (e.g., it is a host device that includes a controller) the USB dongle device 1000 inactivates the expansion connection unit 210 while supporting operation according to the control of the connected host in block 907.

At this time, the basic connection unit 220 in the USB dongle device 1000 is connected to the host, provided with power from the host, and can receive a control signal from the host. For instance, when the wireless communications unit 110 receives a control signal for the operation of wireless communications unit 110 from the host, it initializes the wireless communications unit 110 according to the control signal, and transmits/receives data through the wireless communications unit 110 with the host. In this process, when the USB dongle device 1000 does not include a switch 150 for the state control of the expansion connection unit 210, the operation for a separate state control of the expansion connection unit 210 may not be performed.

When the switch 150 for the state control of expansion connection unit 210 is included in the USB dongle device 1000, and when a designer prepares a design to address an electrical problem through the expansion connection unit 210, e.g., the influx of the static electricity, the USB dongle device 1000 may control the expansion connection unit 210 to change into a floating or a ground state.

Alternatively, if the connected external device is a dongle expanded device at block 905, the USB dongle device 1000 may control to activate the expansion connection unit 210 in block 909. As described above, when the switch 150 is prepared, the USB dongle device 1000 performs the operation for the control of connection state of the expansion connection unit 210. At this time, the USB dongle device 1000 can perform the initialization of the connected dongle expanded device 300. That is, the central processing unit 130 of the USB dongle device 1000 may perform the initialization of the display unit 310, the input unit 330, and the audio input output unit 340 arranged in the dongle expanded device 300 based on the plug 200 and the connector 350. The USB dongle device 1000 may perform the operation according to the input signal sent from the dongle expanded device 300 in block 911.

That is, if user generates an input signal by using the input unit 330 that includes an input function or the display unit 310 is a touch screen type in the dongle expanded device 300, the input signal is sent to the USB dongle device 1000 through the connector 350 and the plug 200. The central processing unit 130 of the USB dongle device 1000 may then perform the function corresponding to the process requested by the sent input signal. Through this process, the USB dongle device 1000 can perform the mobile communications function, the contents playing function, the file store function, and the file edit function based on the built-in central processing unit 130, the wireless communications unit 110, and the data storage unit 120. At this time, by using the expansion connection unit 210, the USB dongle device 1000 may form a direct data link path between each configuration with the central processing unit 130.

As described above, in the process of the USB dongle device 1000 according to an embodiment of the present invention, a selective signal path is formed based on the basic connection unit 220 and the expansion connection unit 210 according to the type of the connected external device. The user function of the USB dongle device 1000 is supported based on the formed signal path. When the signal path is formed based on the expansion connection unit 210, the central processing unit 130 of the USB dongle device 1000 can directly control the display unit 310, the input unit 330, the audio input output unit 340 through the connector 350 and the plug 200.

The USB dongle device 1000 is illustrated based on a simple user function. However, the present invention is not limited to the USB dongle device of the above described simple structure, but can further include elements which was not mentioned or briefly mentioned in the above disclosure, such as a near field communications module for the near field communications, a camera module for taking a picture of static images/moving picture of a subject, an Internet communications module which communicates with the internet network and performs an internet function, and a digital broadcasting module that performs the reception and play function of the digital broadcast. As such, elements that are equivalent to the above mentioned elements may be further included in the device. Moreover, in the USB dongle device 1000 of the present invention, a specific component may be excluded from the above described configuration according to a given type, or may be replaced with another component.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A universal serial bus (USB) dongle device, comprising:
a body; and
a plug formed in an edge of one side of the body, the plug comprising:
a basic connection unit corresponding to a USB basic connection port, and
an expansion connection unit surrounding the basic connection unit, in which at least one signal line is formed.

2. The USB dongle device of claim 1, wherein the expansion connection unit comprises:
a support structure of non-conductive material surrounding the basic connection unit; and
a signal line formed in at least one of an outer and an inner surface of the support structure.

3. The USB dongle device of claim 2, wherein the support structure comprises a shape of a hollow rectangular tube, and the at least one signal line is formed in at least one of four outer surfaces of the rectangular tube.

4. The USB dongle device of claim 1, further comprising at least one of:
a switch unit configured to selectively float or ground each of the signal lines: and a power amplification module configured to amplify a power supplied from a host device.

5. The USB dongle device of claim 4, wherein, when an external device connected through the plug includes a controller, the switch unit is further configured to deactivate the expansion connection unit by setting the signal lines of the expansion connection unit to one of float and ground.

6. The USB dongle device of claim 4, wherein, when an external device does not include a controller while comprising at least one contact terminal that couples to a signal line of the expansion connection unit, the switch is configured to form a signal path between the expansion connection unit and the external device.

7. The USB dongle device of claim 1, wherein the body comprises:
a wireless communications unit configured to support a wireless communications;
a storage unit configured to store data for supporting an operation of the wireless communications unit and a user function of the USB dongle device; and
a central processing unit configured to control the wireless communications unit and the storage and manage communications with an external device connected to the plug.

8. A dongle expanded device connected to a universal serial bus (USB) dongle device, the dongle expanded device comprising:
a connector configured to couple to the USB dongle device;
a power supply unit configured to supply power to the USB dongle device through the connector;
a display unit configured to display data received from the USB dongle device through the connector; and
an audio input/output unit configured to output an audio signal received from the USB dongle device through the connector, and send a collected audio signal to the USB dongle device.

9. The dongle expanded device of claim 8, wherein the dongle expanded device is configured to perform an initialization according to a control of the USB dongle device when connected to the USB dongle device.

10. The dongle expanded device of claim 8, further comprising at least one of:
a charge interface configured to charge the power supply unit; and
a touch panel arranged in an upper surface of the display unit and configured to generate a touch event according to a touch.

11. The dongle expanded device of claim 8, wherein the dongle expanded device further comprises an input unit configured to generate an input signal.

12. The dongle expanded device of claim 8, wherein the connector comprises:
a basic contact terminal configured to be coupled to a basic connection unit of the USB dongle device; and
at least one expansion contact terminal configured to be coupled to an expansion connection unit of the USB dongle device.

13. The dongle expanded device of claim 12, wherein the expansion contact terminals are formed in at least one of four inner surfaces of an insertion cavity of the connector.

14. The dongle expanded device of claim 12, wherein the basic contact terminal comprises a USB basic connection port.

15. An operating method of a USB dongle device, the method comprising:
detecting a connection of the USB dongle device to an external device, the USB dongle device comprising a basic connection unit for USB connection and an expansion connection unit surrounding the basic connection unit that includes at least one signal line; and
controlling a signal path to one of block and maintain a signal path for the expansion connection unit according to a type of the external device.

16. The method of claim 15, wherein controlling a signal path comprises blocking a signal path at the expansion connection unit when the external device comprises a controller.

17. The method of claim 15, wherein controlling a signal path comprises maintaining a signal path at the expansion connection unit when the external device is a dongle expanded device that does not include a controller.

18. The method of claim 17, further comprising:
receiving power from the dongle expanded device when the dongle expanded device does not include a controller; and
performing an initialization based on the supplied power.

19. The method of claim 18, further comprising controlling the initialization of the dongle expanded device.

20. The method of claim 15, further comprising detecting the type of the external device by determining whether the external device is a dongle expanded device.
